(19) United States
(12) Patent Application Publication
(10) Pub. No.: US 2016/0284003 A1
(43) Pub. Date: Sep. 29, 2016

(54) TIME-SENSITIVE COLLABORATIVE FILTERING THROUGH ADAPTIVE MATRIX COMPLETION

(71) Applicant: Xerox Corporation, Norwalk, CT (US)

(72) Inventor: Jean-Michel Renders, Quaix-en-Chartreuse (FR)

(21) Appl. No.: 14/669,153

(22) Filed: Mar. 26, 2015

(51) Int. Cl. G06Q 30/06; G06F 17/30

(52) U.S. Cl. CPC G06Q 30/0631; G06F 17/30528; G06F 17/30525; G06F 17/30365; G06F 17/30324

(57) ABSTRACT

A method for updating a predicted ratings matrix includes receiving one or more observations. Each observation identifies a user, an item and an observed rating of the user for the item. A user bias for the user and an item bias for the item are updated as a function of the rating. Based on the rating and the adapted user and item biases, at least one of a user latent factor matrix and an item latent factor matrix is updated. After the updating of the latent factor matrix or matrices for one of the observations, a predicted ratings matrix is updated as a function of the user latent factor matrix and the item latent factor matrix. The updating of the latent factor matrix or matrices may be performed for each new observation in a time series, so that the updated predicted ratings matrix reflects changes in user preferences and item popularities.

### BACKGROUND

The exemplary embodiment relates to recommender systems and finds particular application in cases where item perception and user tastes vary over time.

Recommender systems are designed to provide automatic recommendations to a user by attempting to predict the preferences or choices of the user. Recommender systems are employed in numerous retail and service applications. For example, an online retailer may provide a website through which a user (i.e., a customer) browses the retailer's catalog of products or services. To promote purchases, the retailer would like to identify and present to the customer specific products or services that the customer is likely to want to purchase. The recommender system, in this application, identifies products or services that are likely to be of interest to the customer, and these products are recommended to the customer.

Collaborative filtering is often used in such systems to provide automatic predictions about the interests of a user by collecting rating information from many users. The ratings can be explicit (e.g., a score given by a user) or implicit (e.g., based on user purchases). The method is based on the expectation that if two users have similar opinions on one item (or a set of items) then they are more likely to have similar opinions on another item than a person randomly chosen. For example, collaborative filtering-based recommendations may be made to a user for television shows, movies, books, and the like, given a partial list of that user's tastes. These recommendations are specific to the user, but use information obtained from many users.

In many collaborative filtering applications, the available data is represented in a matrix data structure. For example, product ratings can be represented as a two-dimensional matrix in which the rows correspond to customers (users) and the columns correspond to products (items), or vice versa. The data structure is typically very sparse, as most users have not purchased or reviewed many of the items.

One problem with recommender systems is that they often fail to provide the level of reactivity to changes that users expect, i.e., the ability to detect and to integrate changes in needs, preferences, popularity, and so forth. For example, suggesting a movie a week or month after its release may be too late. Similarly, it could take only a few good ratings to make an item go from unpopular to popular, or the other way around. A drop in performance has thus been observed when going from random train/test splits, as in a standard cross-validation setting, towards a strict temporal split. For example, the difference in rating prediction accuracy, as measured by the Root Mean Squared Error (RMSE) method, exceeds 5% (absolute) when using one well-known data set, known as MovieLens.

One approach for addressing temporal effects in recommender systems is known as the timeSVD++ algorithm (Yehuda Koren, “Collaborative Filtering with temporal dynamics,” Communications of the ACM, 53(4):8997, 2010). This approach explicitly models the temporal patterns on historical rating data, in order to remove “temporal drift” biases. Time dependencies are modeled parametrically as time-series, typically under the form of linear trends, with a number of parameters to be identified. Other approaches rely on a Bayesian framework and on probabilistic matrix factorization, where a state-space model is introduced to model the temporal dynamics (see, for example, Deepak Agarwal, et al., “Fast online learning through online initialization for time-sensitive recommendation,” Proc. 16th ACM SIGKDD Int'l Conf. on Knowledge Discovery and Data Mining (KDD), pp. 703-712, 2010; Zhengdong Lu, et al., “A spatio-temporal approach to collaborative filtering,” Proc. 3rd ACM Conf. on Recommender Systems (RecSys), pp. 13-20, 2009; and David H Stern, et al., “Matchbox: large scale online Bayesian recommendations,” Proc. 18th Int'l Conf. on World Wide Web (WWW), pp. 111-120, ACM, 2009).

One of the advantages of such methods is that they can be extended to include additional user- or item-related features (addressing, in this way, the cold-start problem). However, in order to remain computationally tractable, they update only either the user factors, or the items factors, but not both factors simultaneously, thereby avoiding the need to rely on rather complex non-linear Kalman filter methods.

Another approach incrementally updates the item- or user-related factor corresponding to a new observation by performing a stochastic gradient step of a quadratic loss function, but allowing only one factor to be updated. The updating decision is taken based on the current number of observations associated to a user or to an item. For example, a user with a high number of ratings will no longer be updated. See, Steffen Rendle et al., “Online-updating regularized kernel matrix factorization models for large-scale recommender systems,” Proc. 2008 ACM Conf. on Recommender Systems (RecSys), 2008.

Tensor factorization approaches have also been adopted to model the temporal effects of the dynamic rating behavior (Liang Xiong, et al., “Temporal collaborative Filtering with Bayesian probabilistic tensor factorization,” Proc. SIAM Intl Conf. on Data Mining (SDM), vol. 10, pp. 211-222, 2010). In this method, user, item and time constitute the three dimensions of the tensors. Tensor factorization is useful for analyzing the temporal evolution of user and item-related factors, but it does not extrapolate rating behavior into the future. More recently, a “reactivity” mechanism in the similarity-based approach to collaborative filtering has been proposed, which updates the similarity measures between users and between items with a form of forgetting factor, allowing the importance of old ratings to decrease (Julien Gaillard, et al., “Flash reactivity: adaptive models in recommender systems,” Proc. 2013 Intl Conf. on Data Mining (DMIN), WORLDCOMP, 2013).

One problem with many of these methods is that they often lack efficiency and scalability to meet the demands of very large recommendation platforms. Some approaches based on Bayesian, probabilistic inference methods (e.g., those based on probabilistic matrix factorizations and non-linear Kalman filters) do not perform well in such settings.

### INCORPORATION BY REFERENCE

The following references, the disclosures of which are incorporated by reference in their entireties, are mentioned:

Recommender systems and collaborative filtering methods are described, for example, in U.S. Pat. No. 7,756,753 and U.S. Pub. Nos. 20130226839, 20140180760, and 20140258027.

### BRIEF DESCRIPTION

In accordance with one aspect of the exemplary embodiment, a method for updating a predicted ratings matrix includes receiving one or more observations. Each observation identifies a user, an item, and an observed rating of the user for the item. A user bias for the user and an item bias for the item are both updated as a function of the observed rating. Based on the observed rating and the adapted user and item biases, the method includes updating at least one row of one or both of a user latent factor matrix and an item latent factor matrix. The user latent factor matrix includes, for each of a set of users including the user, a value for each of a set of latent factors. The item latent factor matrix includes, for each of a set of items including the item, a value for each of the set of latent factors. After updating the user and item latent factor matrices for one or more of the observations, a predicted ratings matrix is updated as a function of the user latent factor matrix and the item latent factor matrix.

At least one of the updating user and item biases, the updating of the at least one row of the at least one of the user latent factor matrix and the item latent factor matrix, and the generating of the predicted ratings matrix may be performed with a processor.

In accordance with another aspect of the exemplary embodiment, a system for updating a predicted ratings matrix includes an adaptive matrix completion component which receives an observation identifying a user, an item and an observed rating of the user for the item and updates a user bias for the user and an item bias for the item as a function of the rating. Based on the observed rating and the adapted user and item biases, updates at least one row of one or both of a user latent factor matrix and an item latent factor matrix. The user latent factor matrix includes, for each of a set of users including the user, a value for each of a set of latent factors. The item latent factor matrix includes, for each of a set of items including the item, a value for each of the set of latent factors. After the updating of the row(s) of the user latent factor matrix and/or the item latent factor matrix, the adaptive matrix completion component updates a predicted ratings matrix as a function of the user latent factor matrix and the item latent factor matrix. Optionally, a recommendation component receives a query, accesses the predicted ratings matrix with the query, and outputs a recommendation based on at least one entry in the predicted ratings matrix. A processor implements the adaptive matrix completion component.

In accordance with another aspect of the exemplary embodiment, a method for recommending items to users includes generating a user latent factor matrix which, for each of a set of users, includes a value for each of a set of latent factors and generating an item latent factor matrix which, for each of a set of items, includes a value for each of the set of latent factors. For each of a series of observations received at different times, the observation identifying a user in the set of users, an item in the set of items, and an observed rating of the user for the item, the method includes updating a user bias for the user and an item bias for the item as a function of the observed rating, and based on the observed rating and the adapted user and item biases, updating at least one row of at least one of the user latent factor matrix and the item latent factor matrix. For at least one of the observations in the set of observations, an updated predicted ratings matrix is generated as a function of the user latent factor matrix and the item latent factor matrix updated based on that observation. A query is received and the updated predicted ratings matrix is accessed with the query. A recommendation based on at least one entry in the updated predicted ratings matrix corresponding to the query is output.

At least one of the updating user and item biases, the updating of the at least one row of at least one of the user latent factor matrix and the item latent factor matrix, and the generating of the updated predicted ratings matrix may be performed with a processor.

### BRIEF DESCRIPTION OF THE DRAWINGS

FIG. 1 is a functional block diagram of an environment in which a system for updating a predicted ratings matrix and making recommendations based on the matrix operates in accordance with one aspect of the exemplary embodiment;

FIG. 2 schematically illustrates matrices used by the system;

FIG. 3 illustrates a method for updating a predicted ratings matrix and making recommendations based on the matrix in accordance with another aspect of the exemplary embodiment;

FIG. 4 is a graph showing plots of RMSE as a function of relative time for the Netflix dataset;

FIG. 5 is a graph showing plots of RMSE as a function of relative time for the MovieLens dataset; and

FIGS. 6 and 7 illustrate examples of adaptation on individual cases.

### DETAILED DESCRIPTION

Aspects of the exemplary embodiment relate to recommender systems for generating a recommendation for a user comprising a predicted item rating or identification of one or more recommended items using a latent factor (or matrix factorization-based) collaborative filtering model. The term “user” as used herein encompasses any person acting alone or as a unit (e.g., a customer, corporation, non-profit organization, or the like) that rates items. An “item” as used herein is a product, service, or other subject of ratings assigned by users.

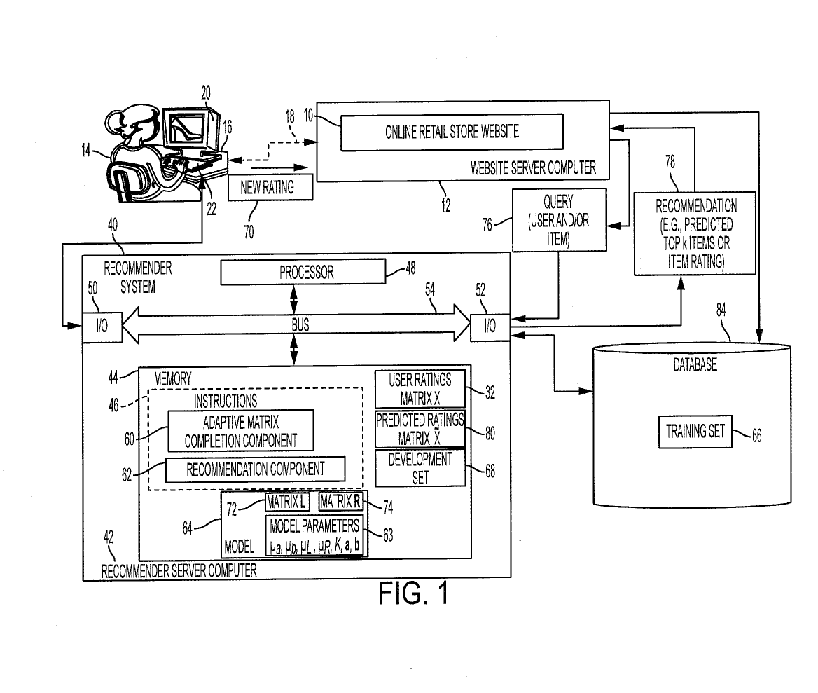

With reference to FIG. 1, in an illustrative example, the users are customers and the items are products or services offered by an online retail store website 10 that is hosted by an Internet-based server computer or computers 12. A customer 14 interacts with the online retail store website 10 using an electronic client device 16, such as a desktop computer, notebook computer, electronic tablet, smartphone, or personal data assistant (PDA). The client device 16 is operatively connected with the online retail store website 10 via a wired or wireless connection 18, such as the Internet (diagrammatically indicated by a dashed line). The electronic device 16 includes a display device 20 and a user input device 22, such as a keyboard, keypad, touchscreen, or the like, which in combination enable the user 14 to view item-related information and rate respective items. Although a single electronic device 16 is shown, it is to be understood that the exemplary online retail store website 10 serves many customers who typically each use their own electronic client device or devices to access the website 10. Each customer is uniquely identified to the website, e.g., through a user ID, which may be linked to identifying information, such as an email address and/or IP address of the client device 16.

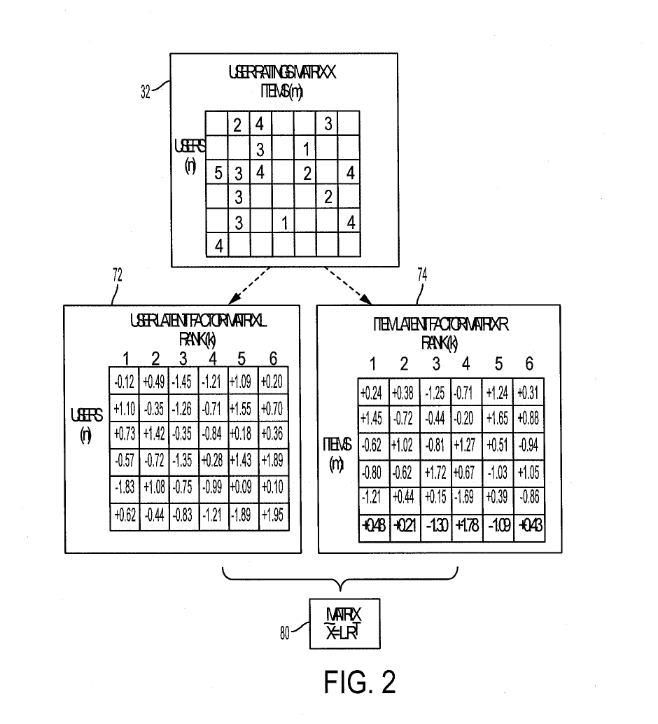

The online retail store website 10 enables users to rate items, such as products or services, available on the website 10. In an illustrative example, the ratings (denoted “observed ratings”) are on a one-to-five star integer scale. However, any other rating scale can be employed. The ratings are suitably organized in a user ratings matrix 32 (FIG. 2), denoted X, in which the rows (n) correspond to users (i.e., customers in this example) and the columns (m) correspond to items (i.e., products or services in this example). The elements of the matrix are the observed ratings. The illustrative matrix 32 includes only n=6 users and m=7 items. However, the number of users may be in the dozens, hundreds, thousands, tens of thousands, hundreds of thousands, millions or more; and the number of items may be in the dozens, hundreds, thousands, tens of thousands, hundreds of thousands, millions or more. The user ratings matrix 32 is typically sparse since most (user, item) elements do not store a rating (that is, a given customer has typically not rated most items, and a given item typically has not been rated by most customers).

During the course of a user's session on the online retail store website 10, it is advantageous to direct recommendations to the user. For this, the website 10 utilizes a recommender system 40, which may be hosted by the server computer 12 or by a separate computing device 42, which may be communicatively connected with the computer 12, as illustrated. In the illustrated embodiment, the website server computer 12 and recommender server computer 42 both have access to a database 30, which stores data previously collected from the users, although other arrangements are contemplated. For example, the website 10 may send raw data to the recommender system 40 which generates and stores the matrix 32 locally.

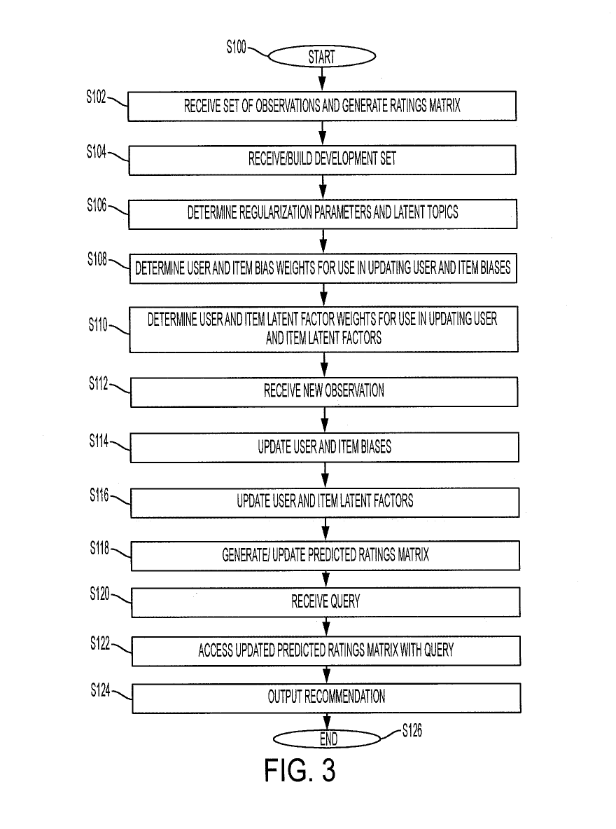

The recommender system includes memory 44 which stores instructions 46 for performing the method described with reference to FIG. 3 and a processor 48, in communication with the memory, for executing the instructions 46. One or more input/output devices 50, 52 allow the system to communicate with external devices, such as the website server computer 12 and/or directly with customer client devices 16. Hardware components 44, 48, 50, 52 of the system 40 communicate via a data/control bus 54.

The instructions 46 include an adaptive matrix completion (AMC) component 60 and a recommendation component 62.

The AMC component 60 initializes parameters 63 of a model 64 based on training and development sets 66, 68 of observations 70. The observations in these sets 66, 68 each cover a number of different users and items in multiple different combinations. The AMC component 60 updates the model 64 and a predicted ratings matrix 80 (denoted \tilde{X}) of predicted ratings, based on new observations 70. The predicted ratings matrix, unlike the sparse user ratings matrix, includes a value in each of the cells. The initial and new observations 70 may include a user identifier (UID), which uniquely identifies the user, an item identifier (IID), which uniquely identifies one (or a set) of items available through the website, and a user rating (UR) for the item selected by the identified user from a range of possible ratings, e.g., as a tuple (<user, item, rating>). The new data may be associated with a time stamp which identifies a time at which the rating was submitted by the user or was received by the system 40 or an identifier indicating the order in which it was received. In particular, the AMC component 60 updates at least one latent factor vector (or row) of user and item factor matrices 72, 74, denoted L and R, into which the user ratings matrix 32 is approximately decomposed (through the predicted ratings matrix matrix 80: \tilde{X}=LR^{T}).

The recommendation component 62 receives as input a query 76 from the website 10 and outputs a recommendation 78 based on the updated predicted ratings matrix 80. Various types of query are contemplated. For example, the query 76 may include a user ID and seek a recommendation of an item (or top k items) to be proposed to the corresponding user 14. To do this, the recommendation component 64 generates predicted ratings for the user for each item available at the online retail store website 10 (or for a subset of those items, such as books or DVDs), ranks the items according to the predicted ratings, and returns the top-n ranked items, possibly excluding items that the user previously consumed or bought. In another embodiment, the query 76 may include an item ID and seek a recommendation for a set of top-n users to receive a proposal for the corresponding item. If the query 76 is a (user, item) pair, then the recommendation component 64 generates the recommendation 78 in the form of a predicted item rating for the item. The predicted item rating is a prediction of the rating that the user of the (user, item) pair would be expected to assign to the item of the (user, item) pair. The recommendation 78 is output by the system to the website 10, which may then display one or more of the recommended items to the user on the display 20 of the client device.

In the illustrated embodiment, the model 64 includes the matrices L and R 72, 74 and the set of parameters 63, which are used in updating the matrices L and R. The model 64, together with the predicted ratings matrix 80 generated therefrom, may be stored in memory 44, although in other embodiments, they may be stored elsewhere, such as in a remote database linked to the system. The training data 66, because of its size, may be stored in a remote database 84, linked to the system, although in other embodiments, it may be stored in memory 44.

The sequence of generating the query 76, receiving the recommendation 78, and displaying the recommendation 78 on the display 20 of the client device 16 can occur in various settings. For example, when a user selects an item for viewing, the online retail store website 10 may generate the query 76 as the (user, item) pair, and then display the store's prediction for the user's rating of the item in the view of the item. To increase user purchases, in another variation when the user views an item in a given department the query 76 is generated as the user alone (not paired with the item) but optionally with the query constrained based on the viewed item (e.g., limited to the department of the store to which the viewed item belongs). The recommendation 78 is then a set of top-n items having the highest predicted rating for the user, where n may be 1, 2, 3 or more, optionally with one or more constraints, such as excluding previously consumed items. These top-n items are then displayed in the view of the selected item, along with suitable language such as “You may also be interested in these other available items:” or some similar explanatory language. The displayed top-n recommended items may be associated with hyperlinks such that user selection of one of the recommended items causes the online retail store website 10 to generate a view of the selected recommended item. In another embodiment, the website may pay for click through advertisements to be displayed next to content on another website. Given the user ID, the top-n recommended items recommended for that user may be displayed in the click-through advertisement (which when clicked on by the user, takes the user to a page of the store website).

The computer system 40 may include one or more computing devices 42, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 44 may represent any type of non-transitory computer readable medium such as random access memory (RAM), read only memory (ROM), magnetic disk or tape, optical disk, flash memory, or holographic memory. In one embodiment, the memory 44 comprises a combination of random access memory and read only memory. In some embodiments, the processor 48 and memory 44 may be combined in a single chip. Memory 44 stores instructions for performing the exemplary method as well as the processed data.

The network interface 50, 52 allows the computer to communicate with other devices via a computer network, such as a local area network (LAN) or wide area network (WAN), or the internet, and may comprise a modulator/demodulator (MODEM) a router, a cable, and and/or Ethernet port.

The digital processor device 48 can be variously embodied, such as by a single-core processor, a dual-core processor (or more generally by a multiple-core processor), a digital processor and cooperating math coprocessor, a digital controller, or the like. The digital processor 48, in addition to executing instructions 46 may also control the operation of the computer 42. Computer 12 may be configured similarly to computer 42, with respect to its hardware.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Having provided an overview of the recommendation system with reference to FIG. 1, some illustrative adaptive matrix completion approaches suitably implemented by the system are described.

As discussed above, recommender systems often face drifts in users' preferences over time. For example, the same user who may give a high rating to an item one week, would give a lower rating to the same item next week if asked for a rating then.

Aspects of the exemplary embodiment provide a system and method for incremental matrix completion that automatically allows the factors related to both users and items to adapt “on-line” to such drifts. Model updates are based on a temporal regularization, ensuring smoothness and consistency over time, while leading to efficient, easily scalable algebraic computations. Experiments on real-world data sets show that these adaptation mechanisms significantly improve the quality of recommendations compared to the static setting.

The exemplary Adaptive Matrix Completion component and method make the system 40 very flexible with respect to dynamic behaviors. Factor matrices 72, can be dynamically and continuously updated, in order to provide recommendations in phase with the very recent past. It may be noted that the method is truly adaptive and not only incremental, in the sense that it can give more weight to recent data rather than uniform weights to all observations.

The exemplary method considers the case where no information other than a set of <user, item, rating> tuples and their respective timestamp is given. It does not address the cold start case, where a completely new user or a new item is appearing, with no associated information. In the method, when receiving a new observation (<user, item, rating> tuple) 70, corresponding entries (rows) of the factor matrices 72, 74 are updated, controlling the trade-off between fitting as close as possible to the new observation and being smooth and consistent with respect to the previous entries in the matrices. This is formalized as a least-squares problem with temporal regularization, coupling the update of both users- and items-related factors. To solve this problem, an iterative algorithm may be employed. This entails the inversion of a K×K matrix, where K is the reduced rank in the matrix factorization. The iterative algorithm converges in a few iterations (typically 2 or 3), so that it can easily update the model, even with a rating rate of several thousand ratings per second.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

### Adaptive Matrix Completion

The AMC component 60 and method can be based on one of the standard static settings of matrix completion for Collaborative Filtering (CF), which is extended to the time-varying case, by adopting an incremental, on-line approach based on temporal regularization.

As noted above, matrix X is an n×m user ratings matrix (n users, m items) 32, which is relatively sparse, i.e., with a lot of missing data. One CF approach amounts to approximating X by a low-rank matrix 80, denoted \tilde{X}, that optimizes a criterion mixing:

a) the approximation quality over observed ratings, typically the sum of squared errors; and

b) a complexity penalty, such as the nuclear norm (also referred to as the trace-norm or Frobenius norm) of \tilde{X}, as a way to recover a low-rank matrix.

See, Benjamin Recht, et al., “Guaranteed minimum rank solutions of matrix equations via nuclear norm minimization,” SIAM Review, 2010, for a fuller description of matrix factorization.

In the present case, assuming the decomposition: \tilde{X}=L. R^{T}, with L and R each having K columns if \tilde{X} is rank K at most. K can be considered as latent factors (hidden topics), which are automatically derived. T represents the transpose operator. User- and item-specific biases (often called user subjective bias and item popularity) are denoted a and b. The nuclear norm problem can be approximated by a minimization problem: find a, b, L and R that minimize the following function:

$${\sum }_{( i , j ) ∈ ω} {( {x}_{i , j} - v - {a}_{i} - {b}_{j} - {\sum }_{k = 1}^{K} {L}_{i , k} {R}_{j , k} )}^{2} + {μ}_{a} {‖ a ‖}^{2} + {μ}_{b} {‖ b ‖}^{2} + {μ}_{L} {‖ L ‖}_{F}^{2} + {μ}_{R} {‖ R ‖}_{F}^{2} \qquad ( 1 )$$

where ω designates the set of available rating tuples 70 (initially the training set 66, subsequently, the development set 68), v is the average rating over ω, and aᵢ, bⱼ, L_{i,k} and R_{j,k} are respectively the elements of a, b, X, L and R, corresponding to user i, item j and latent factor k (where k=1, . . . K). The number K of latent factors can be manually selected or determined automatically. In general, K<<n, and K<<m, e.g., K is at least 5, or at least 10, or at least 20, or at least 50. ∥M∥_{F}² is the squared Frobenius norm of a matrix M (where M can be L or R). The squared Frobenius norm is the sum of the squares of each element (entry) of the matrix. The Frobenius norm is effective as it easily tractable. However other matrix norms can be used, such as the L₁ norm (the sum of absolute values of all elements).

The first part of Eqn. 1 (Σ(.)²) corresponds to the quality of the approximation. It evaluates how similar the profiles of the user and item are by computing the scalar product of respective rows of matrices L and R corresponding to user i and item j. This is subtracted from the corresponding value of the rating x_{i,j} of the item by the user. aᵢ is an element of vector a which is specific to the user (the user bias, which reflects the user's tendency to give different ratings from the average) and bⱼ is an element of vector b which is specific to the item (the item bias). The second part of Eqn. 1 (the set of regularization terms which include norms and respective weights) corresponds to the complexity penalty, which promotes small values in a, b, L and R. μₐ, μ_{b}, μ_{L} and μ_{R} are respective weights in the regularization terms.

The regularization terms in the second part of Eqn. 1, including the ones related to a and b, are particularly significant in the present case. As will be appreciated, in real world cases, the test sets of observations 70 are chronologically posterior to the training and development sets so that, in practice, the standard iid (independent and identically distributed) assumption between the training and the test sets is far from correct and a strong regularization is needed. The optimization function in Eqn. 1 is conventionally solved using Alternating (Regularized) Least Squares or Stochastic Gradient Descent (see, e.g., Benjamin Recht, et al., “Parallel stochastic gradient algorithms for large-scale matrix completion,” Mathematical Programming Computation, 5(2):201-226, 2013).

The selection of the parameters μₐ, μ_{b}, μ_{L}, μ_{R}, (and optionally K) 63 of the model 64 may be performed by grid search on the development set 68. Alternatively, a search is made for the best values of the μₐ and μ_{b} parameters without any factor matrices in the model 64 (i.e., a simple x_{i,j}≈v−aᵢ−bⱼ model); then the parameters μₐ and μ_{b} are fixed and optimized for the remaining parameters.

To take the temporal effects into account, the parameters aᵢ and bⱼ are updated over time. In a simplified case, time is simply the relative time, i.e., a counter is incremented with each new observation 70 received. In an exemplary embodiment, parameters aᵢ and bⱼ are updated with each new observation in a time series, although in other embodiments, the updates may be performed after a group of two or more observations is received. In either case, the updates may be performed in the same way.

Old observations 70 in the development set are automatically retired and no longer considered, e.g., after a certain period of time or number of observations, since the development set is recent in time.

1. Adaptation of User and Item Biases aᵢ and bⱼ

First, a simple model 64 including only the user and item biases aᵢ and bⱼ is considered, before describing an extension to a more complete model based on matrix factorization (MF). When observing a new tuple [symbol] i,j,x_{i,j} [symbol] 70, the respective user and item biases aᵢ and bⱼ are updated as a function of their initial values, the value of the rating x_{i,j}, and the average rating v over all considered observations. This can be achieved by minimizing the following function over aᵢ and bⱼ:

min(x_{i,j}−v−aᵢ−bⱼ)²+α₁(aᵢ−ãᵢ)²+β₁(bⱼ−\tilde{b}ⱼ)² (2)

where ãᵢ and \tilde{b}ⱼ are the values before the adaptation, conventionally designated as time t, and aᵢ and bⱼ are the values after adaptation, designated as time t+1. α₁ and β₁ are bias weights for regularization terms for aᵢ and bⱼ. This function is a trade-off between approximation quality with respect to the new observation 70 (the reconstruction error given in the first part of Eqn. 2) and smoothness in the evolution of the biases (by penalizing large differences between the new and old values of the user and item biases aᵢ and bⱼ in the second part of Eqn. 2). For new users and items, ãᵢ and \tilde{b}ⱼ can be set to 0 or, alternatively, to the average of the biases computed on the non-new items and users.

The values of α₁ and β₁ in Eqn. 2 may be obtained by a grid search on a development set 68 of observations, which is chronologically posterior to the training set 66. Thus, for example, the development set may include all the observations received in the past week, while the training set includes observations prior to that. The aim is to have a set of observations which are recent yet of significant number to provide observations for a significant sample of the users and for a significant sample of the items. The grid search merely involves selecting positive-valued pairs of α₁ and β₁ (e.g., on a logarithmic scale, selected from 0.1, 1, 10, etc.) and determining which pair minimizes Eqn. 1 when Eqn. 2 is used to update aᵢ and bⱼ, for each observation in the development set. Other methods for computing α₁ and β₁ can be used. The resulting α₁ has the same value for all users and β₁ has the same value for all items. In practice a₁ tends to be lower than β₁, since users tastes change more rapidly than item popularities.

The values of α₁ and β₁ may be updated when each new observation is received, based on the immediately prior set of observations forming the development set. Or they may be updated less frequently, such as every day or every week or after a predetermined number of observations. In other embodiments, they are fixed after being determined.

Solving the optimization problem of Eqn. 2 leads to the following update equations:

$$\begin{matrix}{a}_{i} = \frac{( {α}_{1} + {α}_{1} / {β}_{1} ) {\tilde{a}}_{i} + {x}_{i , j} - v - {\tilde{b}}_{j}}{1 + {α}_{1} + {α}_{1} / {β}_{1}} & ( 3 ) \\ {b}_{j} = \frac{( {β}_{1} + {β}_{1} / {α}_{1} ) {\tilde{b}}_{j} + {x}_{i , j} - v - {\tilde{a}}_{i}}{1 + {β}_{1} + {β}_{1} / {α}_{1}} & ( 4 )\end{matrix}$$

Given a new observation x_{i,j} the updated values of aᵢ and bⱼ can be computed using Eqns. 3 and 4 and input into Eqn. 1. This includes updating the vectors a, b to include the new values of aᵢ and bⱼ.

2. Adaptation of User and Item Latent Factors Lᵢ and Rⱼ

In an exemplary embodiment, latent factor matrices L and R are also adapted, which can be performed using the same principle as for aᵢ and bⱼ. This includes, when observing a new tuple [symbol] i,j,x_{i,j} [symbol] , updating Lᵢ and Rⱼ (respectively the i-th row of L and the j-th row of R). This can be achieved by optimizing the following function over Lᵢ and Rⱼ:

min( [symbol] −ΣₖL_{i,k},R_{j,k})²+α₂∥Lᵢ− [symbol] ∥_{F}²+β₂∥Rⱼ− [symbol] ∥_{F}² (5)

where [symbol] is equal to x_{i,j}−v−aᵢ−bⱼ (referred to as the residual rating), and [symbol] and \tilde{R}ⱼ are the values of the corresponding rows before adaptation. For new users and items, the entries of [symbol] and [symbol] can be set to 0 or, alternatively, to the average of the rows of the L and R matrices corresponding to non-new users/items. α₂ and β₂ are latent factor weights for weighting the respective regularization terms which penalize large changes in [symbol] and [symbol] in a given update, i.e., aid in smoothness of the updates.

The values of α₂ and β₂ can be obtained by a grid search on the development set 68, in a similar manner to α₁ and β₂. The values of α₂ and β₂ may be updated when each new observation is received, based on the immediately prior set of observations forming the development set. Or they may be updated less frequently, such as every day or every week or after a predetermined number of observations. In other embodiments, they are fixed after being determined.

Unfortunately, there is no closed-form solution to the problem given by Eqn. (5), due to the coupling between Lᵢ and Rⱼ. However, this may be solved iteratively by applying the following equations recursively for a number of iterations (each iteration being denoted q):

updating the user(i)-related row Lᵢ^{(q)} of the user latent factor matrix according to:

$${L}_{i}^{( q )} = {( {α}_{2} I + {( {R}_{j}^{( q - 1 )} )}^{T} \cdot {R}_{j}^{( q - 1 )} )}^{- 1} \cdot ( {α}_{2} + \cdot {R}_{j}^{( q - 1 )} ) , \qquad ( 6 )$$

and

thereafter, updating the item(j)-related row Rⱼ^{(q)} of the item latent factor matrix according to:

$${R}_{j}^{( q )} = {( {β}_{2} I + {( {L}_{i}^{( q )} )}^{T} \cdot {L}_{i}^{( q )} )}^{- 1} \cdot ( {β}_{2} {\tilde{R}}_{j} + \cdot {L}_{i}^{( q )} ) . \qquad ( 7 )$$

with Lᵢ⁽⁰⁾=\tilde{L}ᵢ and Rⱼ⁽⁰⁾= [symbol] . I is the identity matrix.

In this embodiment Lᵢ is updated with Eqn. 6, based on the Rⱼ of the prior iteration (if any, otherwise based on [symbol] ) and the values of Lᵢ and [symbol] before the update. Then the value Lᵢ^{(q)} is used to compute Rⱼ^{(q)} using Eqn. 7. This value then becomes Rⱼ^{(q-1)} in the next iteration. As will be appreciated, Rⱼ could be updated first. In practice, it has been observed that for all datasets used and the corresponding values of α₂ and β₂, two or three iterations are sufficient to achieve convergence (little or no significant change in Lᵢ and Rⱼ). The final Lᵢ from Eqn. 6 then updates the respective user latent factor terms in matrix L and Rⱼ from Eqn. 7 updates the respective item latent factor terms in matrix R.

In the exemplary embodiment, both Lᵢ and Rⱼ are adapted. In other embodiments only one of Lᵢ and Rⱼ is adapted based on the new observation (the other may be updated for a later observation for the same row).

In the illustrated embodiment, the user and item biases are updated separately from the latent factors by first adapting the biases, fixing them, and then adapting the latent factors. Alternatively, a single set of update equations could be used for simultaneously adapting the bias vectors and the latent factors, i.e., Eqns. 2 and 5 can be coupled into a single one. In practice, however, it may be more efficient to keep both steps separated (giving a faster convergence rate with the same level of accuracy).

One property of the exemplary algorithm is that it is easily parallelizable. Indeed, as a tuple [symbol] i,j,x_{i,j} [symbol] will only modify the rows Lᵢ and Rⱼ of the full L and R matrices, updating the matrices with p tuples with no common users and items can be done in parallel on p processors with a shared memory.

With reference to FIG. 3, the exemplary adaptation method is described, which can be performed with the system of FIG. 1. The method begins at S100.

At S102, a collection 66 of observations is received and used to generate an initial user ratings matrix X.

At S104, a most recent set of observations, prior to a current one, is considered as a development set 68.

At S106, the development set 68 is used to determine suitable values for regularization parameters μₐ, μ_{b}, μ_{L} and μ_{R} (the weights for the regularization terms) and K (the number of latent parameters). This can be done by a grid search, i.e., selecting sets of candidate values from within a range of possible values for each parameter and determining which set minimizes Eqn. 1 over the development set. The values of the model parameters μₐ, μ_{b}, μ_{L}, μ_{R}, a, b, X, L and R are stored in memory.

At S108, user and item bias weights α₁ and β₁ for use in updating user and item biases aᵢ and bⱼ in update equations (Eqns. 3 and 4) are determined. Suitable values of α₁ and β₁ are obtained, e.g., by using a grid search on the development set 68.

At S110, latent factor weights α₁ and β₁ for use in updating user and item latent factor vectors Lᵢ and Rⱼ in update equations (Eqns. 6 and 7) are determined. Suitable values of α₂ and β₂ are obtained, e.g., by using a grid search on the development set 68.

At S112 (time t+1), a new observation [symbol] i,j,x_{i,j} [symbol] 70 is received.

At S114, user and item biases aᵢ and bⱼ are updated, based on the new observation and the preceding values of aᵢ and bⱼ (ãᵢ and \tilde{b}ⱼ), using Eqns. 3 and 4 and the current values of α₁ and β₁ computed at S108. The values of aᵢ and bⱼ may then be fixed for use in S116.

At S116, latent factors in rows Lᵢ and Rⱼ of matrices L and R are updated, based on the new observation and the updated values of a₁ and bⱼ, using iterations of Eqns. 6 and 7 and the current values of α₂ and β₂ computed at S110.

At S118, the updated matrices L and R generated at S116 are multiplied to generate matrix \tilde{X} (\tilde{X}=L. R^{T}). In some embodiments, the latent factor matrices may be updated for each of a series of observations received at different times before generating the predicted ratings matrix \tilde{X}. For example, the AMC component may wait until a query 76 is received by the system before generating the updated predicted ratings matrix \tilde{X} from the latest latent factor matrices L and R.

At S120, a query 76 is received, with a request for a recommendation. The query may include at least one of a user i and an item j.

At S122, the updated predicted ratings matrix \tilde{X} 80 is accessed with the query 76 and the corresponding entry (row, column or single entry, depending on the type of query) in the matrix is extracted. The information extracted from the matrix is then used by the recommendation component to generate a recommendation 78. When the query is a user, the aim is to identify the top-k items. When the query is an item, the aim is to identify the top-k users. When the query is a pair (user,item), the aim is to identify the rating provided by this user for this item.

At S124, the recommendation is output. For example, it may be sent to the website 10 or directly to the user's computer 16.

Later, the method may return to previous step S104 for updating the regularization parameters, user and item bias weights, and latent factor weights, when new observations have been received for updating the development set, or to S112 when a new observation is received.

The method ends at S126.

The method may be performed entirely by the system 40. Or, in another embodiment, the recommendation component may be located on the computer 12 or elsewhere. In this embodiment, after updating the predicted ratings matrix, the matrix may be sent to the website 10 for making recommendations.

The exemplary system and method can provide a fast, scalable, easily parallelizable on-line algorithm that updates simultaneously item-related and user-related factors in an adaptive matrix completion framework. On the standard Benchmark datasets of Collaborative Filtering, the algorithm gives prediction errors that are smaller than existing adaptive methods based on matrix completion.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 42, (for example, an internal hard drive of RAM), or may be separate (for example, an external hard drive operatively connected with the computer 42), or may be separate and accessed via a digital data network such as a local area network (LAN) or the Internet (for example, as a redundant array of inexpensive of independent disks (RAID) or other network server storage that is indirectly accessed by the computer 42, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method for performing matrix updates and/or making recommendations. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

The method finds application in a variety of applications, including recommendation of items such as consumer products and services, e.g., books, movies, electrical and electronic goods, clothing, travel services, and the like. Items may also be workers/jobs in an HR scenario, locations or paths in a transportation network, advertising tags and creatives in on-line display advertising, and the like. In many of these recommendation scenarios, the environment is highly dynamic and not stationary, which precludes the use of standard static recommendation algorithms.

Without intending to limit the scope of the exemplary embodiment, the following examples demonstrate the application of the method to existing ratings datasets.

### Examples

The method described above was tested on three datasets: MovieLens (1 million ratings), Vodkaster, a movie recommendation website favored by informed movie watchers (2 million ratings), and Netflix (2 million ratings). The datasets were divided into 3 temporal (chronologically ordered) splits: training (Train), development (Dev) (20 k), and testing (Test) (20 k). The three datasets show very different characteristics: Netflix has a high number of users and is spread over a short time period (less than 10 months, the Dev and Test sets each represent 1 week). MovieLens has a high number of users and is spread over a longer time period. Vodkaster has a low number of users and is spread over a short time period (one year), but users tend to very “loyal” and active.

TABLE 1 shows results with Matrix Factorization on Vodkaster, Netflix and MovieLens Test sets. The exemplary method is compared with other methods. SGD and PA correspond respectively to the update equations given by the Stochastic Gradient Descent (SGD) algorithm and On-Line Passive Aggressive (PA) algorithm, with tuned learning rates and conservative/corrective parameters. The PA algorithm is described in Blondel, et al., “Online passive-aggressive algorithms for non-negative matrix factorization and completion,” Proc. 17th Intl Conf. on Artificial Intelligence and Statistics, AIS-TATS 2014, pp. 96-104 (2014). RegLS corresponds to the simple model with biases identified by regularized least squares. AMF designates the exemplary prediction model based on Adaptive Matrix Factorization. The Baseline 1, MF(on residuals), and RegLS are all static methods, while the rest are adaptive.

In order to be adaptive, SGD may be used with a constant learning rate. More precisely, when observing a new tuple [symbol] i,j,x_{i,j} [symbol] , the SGD update equations are:

$$\begin{matrix}{a}_{i} = ( 1 - \frac{{μ}_{a}}{{n}_{i}} {η}_{a} ) {\tilde{a}}_{i} + 2 {η}_{a} ( {x}_{i , j} - v - {\tilde{a}}_{i} - {\tilde{b}}_{j} ) & ( 8 ) \\ {b}_{j} = ( 1 - \frac{{μ}_{b}}{{n}_{j}} {η}_{b} ) {\tilde{b}}_{j} + 2 {η}_{b} ( {x}_{i , j} - v - {\tilde{a}}_{i} - {\tilde{b}}_{j} ) & ( 9 ) \\ {L}_{i} = ( 1 - \frac{{μ}_{L}}{{n}_{i}} {η}_{L} ) {\tilde{L}}_{i} + 2 {η}_{L} ( {x}_{i , j} - v - {\tilde{a}}_{i} - {\tilde{b}}_{j} - {Σ}_{k} ) {\tilde{R}}_{j} & ( 10 ) \\ {R}_{j} = ( 1 - \frac{{μ}_{L}}{{n}_{j}} {η}_{R} ) {\tilde{R}}_{j} + 2 {η}_{R} ( {x}_{i , j} - v - {\tilde{a}}_{i} - {\tilde{b}}_{j} - {Σ}_{k} ) {\tilde{L}}_{l} & ( 11 )\end{matrix}$$

where nᵢ and nⱼ are respectively the current number of ratings that user i has given and the current number of ratings that item j has received. The learning rates ηₐ, η_{b}, η_{L} and η_{R} are tuned using the development set (which is posterior to the training set).

The update equations of the Passive-Aggressive (PA) algorithm are described in Blondel, et al., considering only the version where the non-negative constraints are relaxed. Similar to the SGD algorithm, the PA algorithm uses four constants (the analogs of ηₐ, η_{b}, η_{L} and η_{R}), denoted Cₐ, C_{b}, C_{L}, and C_{R}, that control the trade-off between being conservative (time smoothness) and corrective (to fit the new observation). Once again, Cₐ, C_{b}, C_{L}, and C_{R} are tuned using the development set.

The exemplary adaptation algorithm was considered in the case where the latent factors related to both the users and the items are adapted. The exemplary adaptation algorithm was also considered in the case where only the latent factors related to the items are adapted, which offers the advantage to be completely closed-form, with no iteration (equation (7) is used only once, as Lᵢ is not adapted: Lᵢ^{(q)}=Lᵢ^{(q-1)}= [symbol] .

TABLE 1
Results

| | | RMSE | MAE | MAPE |
|---|---|---|---|---|
| Vodkaster | Baseline 1 x_{i,j} = ν | 1.1158 | 0.89239 | 0.5296 |
| | RegLS | 0.8465 | 0.6603 | 0.3477 |
| | MF(on residuals)—static MF | 0.8177 | 0.631 | 0.3294 |
| | SGD | 0.7976 | 0.6184 | 0.3141 |
| | PA | 0.7998 | 0.6201 | 0.3160 |
| | AMF-Adapting aᵢ and bⱼ—but | 0.7919 | 0.6101 | 0.3079 |
| | only Rⱼ | | | |
| | AMF-Adapting aᵢ and bⱼ—Lᵢ | 0.7805 | 0.5993 | 0.3031 |
| | and Rⱼ | | | |
| Netflix | Baseline 1 x_{i,j} = μ | 1.0484 | 0.8669 | 0.3209 |
| | RegLS | 0.9344 | 0.7322 | 0.2755 |
| | MF(on residuals)—static MF | 0.9161 | 0.7118 | 0.27 |
| | SGD | 0.8824 | 0.6819 | 0.2594 |
| | PA | 0.8849 | 0.6836 | 0.2601 |
| | AMF-Adapting aᵢ and bⱼ—but | 0.8701 | 0.6699 | 0.2524 |
| | only Rⱼ | | | |
| | AMF-Adapting aᵢ and bⱼ—Lᵢ | 0.8685 | 0.6678 | 0.2506 |
| | and Rⱼ | | | |
| MovieLens | Baseline 1 x_{i,j} = μ | 1.0976 | 0.90965 | 0.385 |
| | RegLS | 0.9194 | 0.713 | 0.3011 |
| | MF(on residuals)—static MF | 0.9047 | 0.7012 | 0.2943 |
| | SGD | 0.8544 | 0.6632 | 0.2625 |
| | PA | 0.8530 | 0.6610 | 0.2603 |
| | AMF-Adapting aᵢ and bⱼ—but | 0.8519 | 0.6610 | 0.2617 |
| | only Rⱼ | | | |
| | AMF-Adapting aᵢ and bⱼ—Lᵢ | 0.8435 | 0.6528 | 0.2576 |
| | and Rⱼ | | | |

The results in TABLE 1 show that the Adaptive method of matrix factorization improves the performance according to RMSE (root mean squared error), MAE (mean absolute error), and MAPE (mean absolute percentage error) metrics. Lower values are better for each performance metric.

The results suggest that the adaptation of both Lᵢ and Rⱼ gives an improvement over only updating Rⱼ, although Rⱼ updates alone still show improvements.

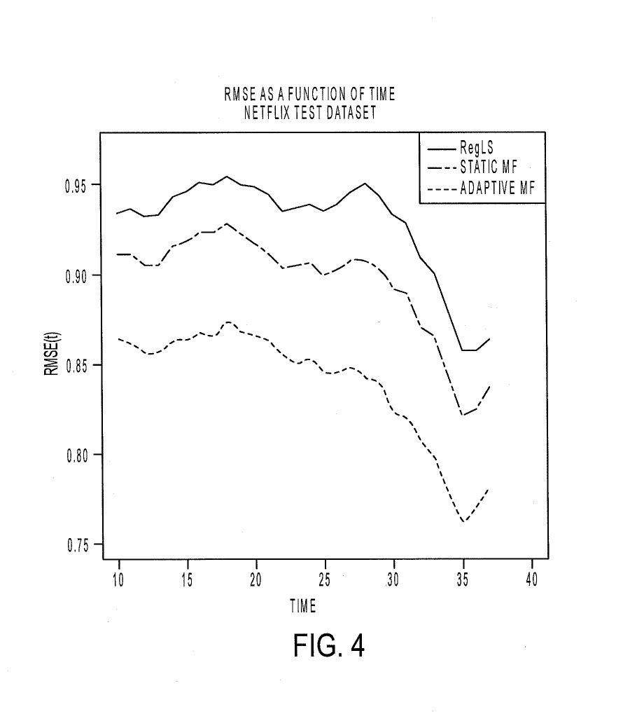

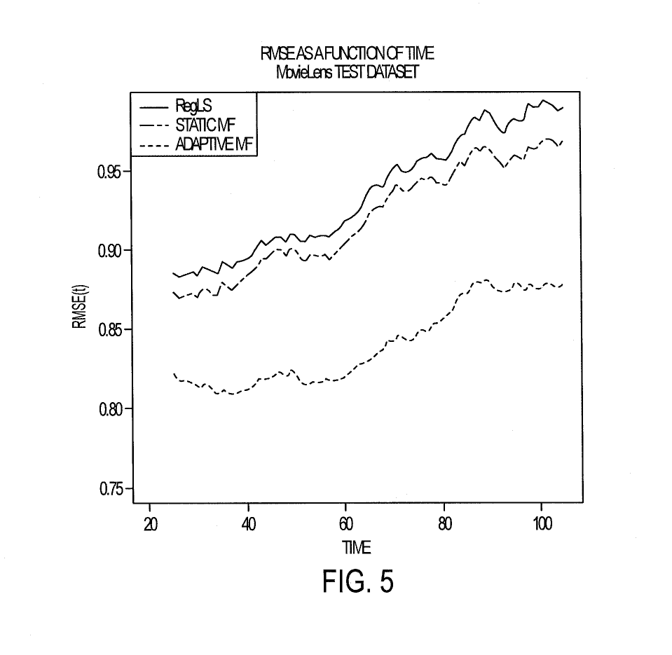

FIGS. 4 and 5 are plots of RMSE as a function of relative time for the Netflix and MovieLens Datasets. The effect of dynamic adaptation over time is evident. Each point of coordinates x=n corresponds to the average RMSE after observing n ratings from the user (starting from the beginning of the test set), the average being computed over the users who have rated at least n items in the test set. This corresponds to a relative user-centric timescale and shows that, without adaptation, prediction errors increase, while it stabilizes to a much lower value with adaptation.

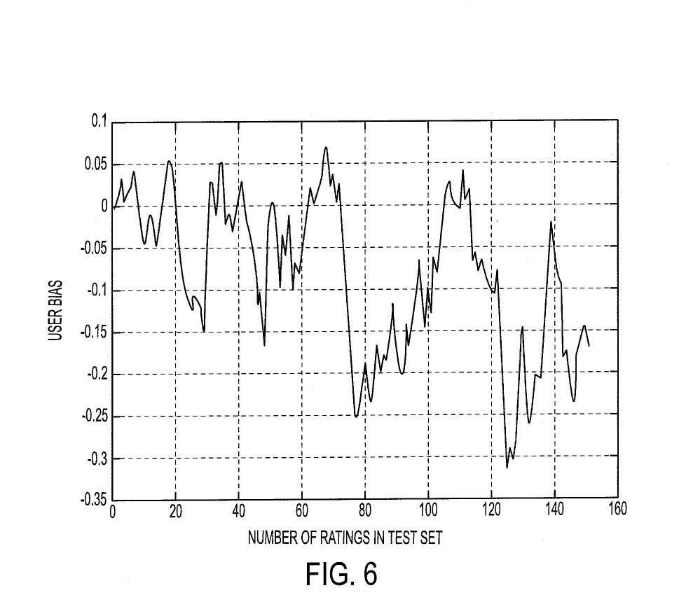

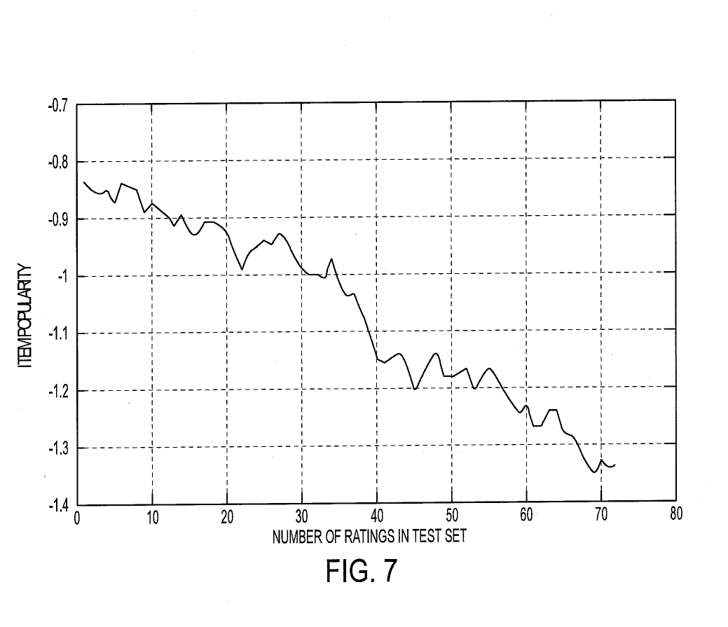

The method allows observations of how users change their bias and how items change their popularity over time. FIGS. 6 and 7 illustrate examples of adaptation on individual cases. FIG. 6 illustrates the case of a user who has already been observed 55 times in the training and development datasets. FIG. 7 illustrates the case of an item which has already been observed 21 times in the training and development datasets.

Additionally, it can be seen that the Netflix and Vodkaster datasets are totally different from a dynamical point of view. On Vodkaster, users are very dynamic while items are rather static in term of popularity, or at least vary much more slowly. On Netflix, the opposite tendency is observed (static users and dynamic items).

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for updating a predicted ratings matrix comprising:
receiving at least one observation, each observation identifying a user, an item, and an observed rating of the user for the item;
for each of the at least one observation:
updating a user bias for the user and an item bias for the item as a function of the observed rating;
based on the observed rating and the adapted user and item biases, updating at least one row of at least one of:
a user latent factor matrix which, for each of a set of users including the user, includes a value for each of a set of latent factors, and
an item latent factor matrix which, for each of a set of items including the item, includes a value for each of the set of latent factors; and
thereafter, updating a predicted ratings matrix as a function of the user latent factor matrix and the item latent factor matrix for one of the at least one observations,
wherein at least one of the updating user and item biases, the updating of the at least one row of the at least one of user latent factor matrix and the item latent factor matrix, and the generating of the predicted ratings matrix is performed with a processor.

2. The method of claim 1, further comprising receiving a query, accessing the predicted ratings matrix with the query, and outputting a recommendation based on an entry, row, or column in the predicted ratings matrix corresponding to the query.

3. The method of claim 1, wherein the updating of the user latent factor matrix comprises updating at least one latent factor vector of the user latent factor matrix and wherein the updating of the item latent factor matrix comprises updating at least one latent factor vector of the item latent factor matrix.

4. The method of claim 1, wherein the user bias is updated as a function of bias weights for regularization terms which penalize larger changes in the user bias greater than smaller changes.

5. The method of claim 4, wherein the user bias aᵢ is computed as a function of
$$\frac{( {α}_{1} + {α}_{1} / {β}_{1} ) {\tilde{a}}_{i} + {x}_{i , j} - v - {\tilde{b}}_{j}}{1 + {α}_{1} + {α}_{1} / {β}_{1}} ,$$
where x_{i,j} is the observed rating for the pair <user i, item j>,
ãᵢ and \tilde{b}ⱼ are values of the user bias and item bias before the adaptation,
v is an average rating computed for a set of observations; and
α₁ and β₁ are the bias weights for the regularization terms.

6. The method of claim 1, wherein the item bias is updated as a function of bias weights for regularization terms which penalize larger changes in the item bias greater than smaller changes.

7. The method of claim 6, wherein the item bias bⱼ is computed as a function of
$$\frac{( {β}_{1} + {β}_{1} / {α}_{1} ) {\tilde{b}}_{j} + {x}_{i , j} - v - {\tilde{a}}_{i}}{1 + {β}_{1} + {β}_{1} / {α}_{1}} ,$$
where x_{i,j} is the observed rating for the pair <user i, item j>,
ãᵢ and \tilde{b}ⱼ are values of the user bias and item bias before the adaptation,
v is an average rating computed for a set of observations, and
α₁ and β₁ are the bias weights for the regularization terms.

8. The method of claim 1, wherein the updating of the at least one of the user latent factor matrix and the item latent factor matrix includes updating both of the user latent factor matrix and the item latent factor matrix based on the observed rating and the adapted user and item biases.

9. The method of claim 8, wherein the updating of the user latent factor matrix and the item latent factor matrix includes iteratively updating a user-related row of the user latent factor matrix and an item-related row of the item latent factor matrix.

10. The method of claim 1, wherein the updating of the user latent factor matrix and the item latent factor matrix includes:
updating the user(i)-related row Lᵢ^{(q)} of the user latent factor matrix according to:
$${L}_{i}^{( q )} = {( {α}_{2} I + {( {R}_{j}^{( q - 1 )} )}^{T} \cdot {R}_{j}^{( q - 1 )} )}^{- 1} \cdot ( {α}_{2} + \cdot {R}_{j}^{( q - 1 )} ) , and$$
thereafter, updating the item(j)-related row Rⱼ^{(q)} of the item latent factor matrix according to:
$${R}_{j}^{( q )} = {( {β}_{2} I + {( {L}_{i}^{( q )} )}^{T} \cdot {L}_{i}^{( q )} )}^{- 1} \cdot ( {β}_{2} {\tilde{R}}_{j} + \cdot {L}_{i}^{( q )} ) .$$

11. The method of claim 1, further comprising at least one of:
a) learning bias weights for the updating of the user bias and the item bias, the bias weights being learned on a development set of observations, each of the observations in the development set identifying a respective user, a respective item and a respective observed rating of the user for the item; and
b) learning latent factor weights for the updating of the user and item latent factor matrices, the latent factor weights being learned on the development set of observations.

12. The method of claim 11, wherein the bias weights are learned by optimizing a function of the respective user bias and the respective item bias on the development set.

13. The method of claim 12, wherein the function optimized is a function of an approximation quality over observed ratings and a complexity penalty.

14. The method of claim 12, wherein the function to be optimized is:
$$min {\sum }_{( i , j ) ∈ ω} {( {x}_{i , j} - v - {a}_{i} - {b}_{j} - {\sum }_{k = 1}^{K} {L}_{i , k} {R}_{j , k} )}^{2} + {μ}_{a} {‖ a ‖}^{2} + {μ}_{b} {‖ b ‖}^{2} + {μ}_{L} {‖ L ‖}_{F}^{2} + {μ}_{R} {‖ R ‖}_{F}^{2}$$
where ω designates the set of available observations, v is the average rating over ω, and a₁, bⱼ, x_{i,j}, L_{i,k} and R_{j,k} are respectively the elements of a, b, X, L and R, corresponding to user i, item j and latent factor k.

15. The method of claim 1, wherein the at least one observation includes a plurality of observations received at different times.

16. The method of claim 15, wherein the updating of the predicted ratings matrix is performed as a function of the user latent factor matrix and the item latent factor matrix for the latest of the observations.

17. The method of claim 1, further comprising outputting the predicted ratings matrix or a recommendation based thereon.

18. A computer program product comprising a non-transitory recording medium storing instructions, which when executed on a computer, causes the computer to perform the method of claim 1.

19. A system comprising memory which stores instructions for performing the method of claim 1 and a processor which executes the instructions.

20. A system for updating a predicted ratings matrix comprising:
an adaptive matrix completion component which:
receives an observation identifying a user, an item and an observed rating of the user for the item;
updates a user bias for the user and an item bias for the item as a function of the observed rating;
based on the observed rating and the adapted user and item biases, updates at least one row of at least one of:
a user latent factor matrix which, for each of a set of users including the user, includes a value for each of a set of latent factors, and
an item latent factor matrix which, for each of a set of items including the item, includes a value for each of the set of latent factors; and
after the updating of the at least one of the user latent factor matrix and the item latent factor matrix, updates a predicted ratings matrix as a function of the user latent factor matrix and the item latent factor matrix;
optionally, a recommendation component which receives a query, accesses the predicted ratings matrix with the query, and outputs a recommendation based on at least one entry in the predicted ratings matrix; and
a processor which implements the adaptive matrix completion component.

21. A method for recommending items to users comprising:
generating a user latent factor matrix which, for each of a set of users, includes a value for each of a set of latent factors;
generating an item latent factor matrix which, for each of a set of items, includes a value for each of the set of latent factors;
for each of a series of observations received at different times, the observation identifying a user in the set of users, an item in the set of items, and an observed rating of the user for the item:
updating a user bias for the user and an item bias for the item as a function of the observed rating; and
based on the observed rating and the adapted user and item biases, updating at least one row of at least one of the user latent factor matrix and the item latent factor matrix;
for at least one of the observations in the set of observations, generating an updated predicted ratings matrix as a function of the user latent factor matrix and the item latent factor matrix updated based on that observation;
receiving a query;
accessing the updated predicted ratings matrix with the query; and
outputting a recommendation based on at least one entry in the updated predicted ratings matrix corresponding to the query,
wherein at least one of the updating user and item biases, the updating of the at least one row of the at least one of the user latent factor matrix and the item latent factor matrix, and the generating of the updated predicted ratings matrix is performed with a processor.
